(19) United States
(12) Patent Application Publication
(10) Pub. No.: US 2025/0096968 A1
(43) Pub. Date: Mar. 20, 2025

(54) METHOD FOR TRANSMITTING AND RECEIVING SIGNAL IN WIRELESS COMMUNICATION SYSTEM, AND DEVICE FOR SUPPORTING SAME

(71) Applicant: LG ELECTRONICS INC., Seoul (KR)

(72) Inventors: Kukheon CHOI, Seoul (KR); Kangjae JUNG, Seoul (KR); Byungwoon JUNG, Seoul (KR); Soyeon LEE, Seoul (KR); Dongjin KIM, Seoul (KR); Byeongyong PARK, Seoul (KR)

(21) Appl. No.: 18/726,633

(22) PCT Filed: Nov. 25, 2022
(86) PCT No.: PCT/KR2022/018811

§ 371 Date: Jul. 3, 2024

(30) Foreign Application Priority Data
Jan. 5, 2022 (KR) 10-2022-0001243

(51) Int. Cl. H04L 5/00

(52) U.S. Cl. CPC H04L 5/0048

(57) ABSTRACT

An embodiment relates to a next-generation wireless communication system for supporting a higher data transmission rate, etc. than that of a 4th generation (4G) wireless communication system. According to an embodiment, a method for transmitting and receiving a signal in a wireless communication system and a device for supporting same may be provided, and another embodiment may be provided.

### CROSS-REFERENCE TO RELATED APPLICATIONS

This application is a National Phase application under 35 U.S.C. 371 of International Application No. PCT/KR2022/018811, filed on Nov. 25, 2022, which claims the benefit of Korean Applications No. 10-2022-0001243, filed on Jan. 5, 2022, the contents of which are incorporated by reference herein in their entirety.

### TECHNICAL FIELD

An embodiment relates to a wireless communication system.

### BACKGROUND ART

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

### SUMMARY

An embodiment may provide a method of transmitting and receiving a signal in a wireless communication system, and an apparatus supporting the same.

It will be appreciated by persons skilled in the art that the objects that could be achieved with the embodiment is not limited to what has been particularly described hereinabove and the above and other objects that the embodiment could achieve will be more clearly understood from the following detailed description.

An embodiment may provide a method of transmitting and receiving a signal in a wireless communication system, and an apparatus supporting the same.

According to an embodiment, a method performed by a user equipment (UE) in a wireless communication system may be provided.

According to an embodiment, the method may include receiving first configuration information related to a channel state information reference signal (CSI-RS).

According to an embodiment, the first configuration information may include at least one of information related to one or more CSI-RS resources for the CSI-RS or information related to a CSI-RS resource set including the one or more CSI-RS resources.

According to an embodiment, the method may include receiving second configuration information related to orbital angular momentum (OAM).

According to an embodiment, the second configuration information may include at least one of information related to one or more OAM resources or information related to an OAM resource set including the OAM resources.

According to an embodiment, the method may include performing an operation related to OAM-based communication based on the second configuration information.

According to an embodiment, the one or more OAM resources may be for measuring an OAM state.

According to an embodiment, at least one of the OAM resource set including the one or more CSI-RS resources, the one or more OAM resources, and one or more synchronization signal/physical broadcast channel (SS/PBCH) block resources or the CSI-RS resource set including the one or more CSI-RS resources and the one or more OAM resources may be satisfied.

According to an embodiment, based on the OAM resource set being periodically allocated,

According to an embodiment, a periodicity of the periodically allocated OAM resource set may be equal to a periodicity of the CSI-RS identified based on the first configuration information, or may be identified based on the second configuration information, and an offset of the periodically allocated OAM resource set may be equal to an offset of the CSI-RS identified based on the first configuration information, or may be identified based on the second configuration information.

According to an embodiment, the method may include receiving downlink control information (DCI) including information indicating whether to activate an OAM state measurement.

According to an embodiment, based on the information indicating activation of the OAM state measurement, the OAM state may be measured based on the one or more OAM resources.

According to an embodiment, based on the information indicating deactivation for the OAM state measurement, the one or more OAM resources may be used as one or more CSI-RS resources different from the one or more CSI-RS resources.

According to an embodiment, the method may further include transmitting information related to CSI in response to the first configuration information.

According to an embodiment, the information related to the CSI may include information related to a CSI-RS resource indicator (CRI).

According to an embodiment, at least one of the one or more OAM resources or the OAM resource set may be received based on a beam corresponding to the CRI or a beam having a quasi co-location (QCL) relationship with the beam corresponding to the CRI.

According to an embodiment, performing the operation related to OAM-based communication may include transmitting information related to the OAM state.

According to an embodiment, the method may include transmitting UE capability information about whether the UE supports the OAM.

According to an embodiment, based on the UE capability information corresponding to the UE supporting the OAM, the second configuration information may be received, and the operation related to OAM-based communication may be performed.

According to an embodiment, a UE operating in a wireless communication system may be provided.

According to an embodiment, the UE may include a transceiver and at least one processor coupled to the transceiver.

According to an embodiment, the at least one processor may be configured to receive first configuration information related to a CSI-RS.

According to an embodiment, the first configuration information may include at least one of information related to one or more CSI-RS resources for the CSI-RS or information related to a CSI-RS resource set including the one or more CSI-RS resources.

According to an embodiment, the at least one processor may be configured to receive second configuration information related to OAM.

According to an embodiment, the second configuration information may include at least one of information related to one or more OAM resources or information related to an OAM resource set including the OAM resources.

According to an embodiment, the at least one processor may be configured to perform an operation related to OAM-based communication based on the second configuration information.

According to an embodiment, the one or more OAM resources may be for measuring an OAM state.

According to an embodiment, the at least one processor may be configured to communicate with at least one of a mobile terminal, a network, or an autonomous driving vehicle other than a vehicle including the UE.

According to an embodiment, a method performed by a base station (BS) in a wireless communication system may be provided.

According to an embodiment, the method may include transmitting first configuration information related to a CSI-RS.

According to an embodiment, the first configuration information may include at least one of information related to one or more CSI-RS resources for the CSI-RS or information related to a CSI-RS resource set including the one or more CSI-RS resources.

According to an embodiment, the method may include transmitting second configuration information related to OAM.

According to an embodiment, the second configuration information may include at least one of information related to one or more OAM resources or information related to an OAM resource set including the OAM resources.

According to an embodiment, the method may include performing an operation related to OAM-based communication based on the second configuration information.

According to an embodiment, the one or more OAM resources may be for measuring an OAM state.

According to an embodiment, a BS operating in a wireless communication system may be provided.

According to an embodiment, the BS may include a transceiver and at least one processor coupled to the transceiver.

According to an embodiment, the processor may be configured to transmit first configuration information related to a CSI-RS.

According to an embodiment, the first configuration information may include at least one of information related to one or more CSI-RS resources for the CSI-RS or information related to a CSI-RS resource set including the one or more CSI-RS resources.

According to an embodiment, the processor may be configured to transmit second configuration information related to OAM.

According to an embodiment, the second configuration information may include at least one of information related to one or more OAM resources or information related to an OAM resource set including the OAM resources.

According to an embodiment, the processor may be configured to perform an operation related to OAM-based communication based on the second configuration information.

According to an embodiment, the one or more OAM resources may be for measuring an OAM state.

According to an embodiment, an apparatus operating in a wireless communication system may be provided.

According to an embodiment, the apparatus may include at least one processor, and at least one memory operably coupled to the at least one processor, and storing at least one instruction causing the at least one processor to perform operations, based on being executed.

According to an embodiment, the operations may include receiving first configuration information related to a CSI-RS.

According to an embodiment, the first configuration information may include at least one of information related to one or more CSI-RS resources for the CSI-RS or information related to a CSI-RS resource set including the one or more CSI-RS resources;

According to an embodiment, the operations may include receiving second configuration information related to OAM.

According to an embodiment, the second configuration information may include at least one of information related to one or more OAM resources or information related to an OAM resource set including the OAM resources.

According to an embodiment, the operations may include performing an operation related to OAM-based communication based on the second configuration information.

According to an embodiment, the one or more OAM resources may be for measuring an OAM state.

According to an embodiment, a non-transitory processor-readable medium storing at least one instruction causing at least one processor to perform operations may be provided.

According to an embodiment, the operations may include receiving first configuration information related to a CSI-RS.

According to an embodiment, the first configuration information may include at least one of information related to one or more CSI-RS resources for the CSI-RS or information related to a CSI-RS resource set including the one or more CSI-RS resources;

According to an embodiment, the operations may include receiving second configuration information related to OAM.

According to an embodiment, the second configuration information may include at least one of information related to one or more OAM resources or information related to an OAM resource set including the OAM resources.

According to an embodiment, the operations may include performing an operation related to OAM-based communication based on the second configuration information.

According to an embodiment, the one or more OAM resources may be for measuring an OAM state.

The above-described embodiment is only part of embodiments, and various embodiments reflecting the technical features of the embodiment may be derived and understood by those skilled in the art from the following detailed description.

According to an embodiment, a signal may be effectively transmitted and received in a wireless communication system.

It is to be understood that both the foregoing general description and the following detailed description of the disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a diagram illustrating physical channels and a signal transmission method using the physical channels, which may be used in the embodiment.

FIG. 2 is a diagram illustrating an example of a communication structure providable in a 6th generation (6G) system applicable to the disclosure.

FIG. 3 is a diagram illustrating an exemplary orbital angular momentum (OAM) antenna to which an embodiment is applicable.

FIG. 4 is a diagram illustrating an exemplary OAM antenna to which an embodiment is applicable.

FIG. 5 is a diagram illustrating an exemplary circular array structure to which an embodiment is applicable.

FIG. 6 is a diagram illustrating exemplary OAM with orthogonal beams to which an embodiment is applicable.

FIG. 7 is a diagram illustrating exemplary OAM with non-orthogonal beams according to an embodiment.

FIG. 8 is a diagram illustrating exemplary angular momentum to which an embodiment is applicable.

FIG. 9 is a diagram exemplary OAM communication according to an embodiment.

FIG. 10 is a diagram illustrating an exemplary OAM transmission and reporting method for OAM multiplexing/diversity according to an embodiment.

FIG. 11 is a diagram illustrating an exemplary OAM transmission and reporting method for OAM multiplexing/diversity according to an embodiment.

FIG. 12 is a diagram illustrating an exemplary OAM transmission and reporting method for OAM multiplexing/diversity according to an embodiment.

FIG. 13 is a simplified diagram illustrating a method of operating a UE and a network node according to an embodiment.

FIG. 14 is a simplified diagram illustrating a method of operating a UE and a network node according to an embodiment.

FIG. 15 is a flowchart illustrating a method of operating a UE according to an embodiment.

FIG. 16 is a flowchart illustrating a method of operating a network node according to an embodiment.

FIG. 17 is a diagram illustrating devices that implement an embodiment of the disclosure.

FIG. 18 illustrates an exemplary communication system applied to an embodiment of the disclosure.

FIG. 19 illustrates exemplary wireless devices applied to an embodiment.

FIG. 20 illustrates other exemplary wireless devices applied to an embodiment.

FIG. 21 illustrates an exemplary portable device applied to an embodiment.

FIG. 22 illustrates an exemplary vehicle or autonomous driving vehicle applied to an embodiment.

FIG. 23 is a diagram illustrating an exemplary artificial intelligence (AI) device to which an embodiment is applied.

### DETAILED DESCRIPTION

The embodiment is applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

The embodiment is described in the context of a 3GPP communication system (e.g., including LTE, NR, 6G, and next-generation wireless communication systems) for clarity of description, to which the technical spirit of the embodiment is not limited. For the background art, terms, and abbreviations used in the description of the embodiment, refer to the technical specifications published before the disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

### 3GPP System

### Physical Channels and Signal Transmission and Reception

In a wireless access system, a UE receives information from a base station (BS) on a downlink (DL) and transmits information to the BS on an uplink (UL). The information transmitted and received between the UE and the BS includes general data information and various types of control information. There are many physical channels according to the types/usages of information transmitted and received between the BS and the UE.

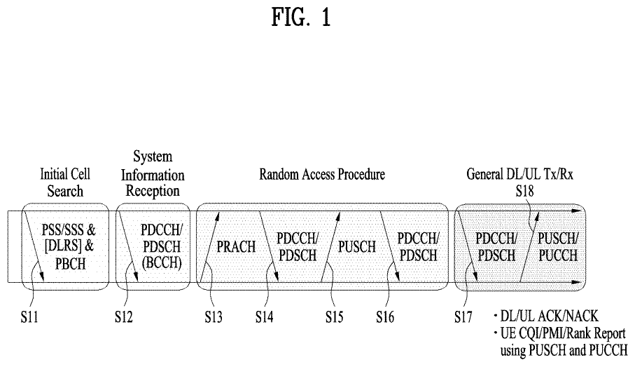

FIG. 1 is a diagram illustrating physical channels and a signal transmission method using the physical channels, which may be used in the embodiment.

When powered on or when a UE initially enters a cell, the UE performs initial cell search involving synchronization with a BS in step S11. For initial cell search, the UE receives a synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S12.

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a physical uplink shared channel (PUSCH) by using scheduling information in the RAR (S15), and perform a contention resolution procedure including reception of a PDCCH signal and a PDSCH signal corresponding to the PDCCH signal (S16).

Aside from the above 4-step random access procedure (4-step RACH procedure or type-1 random access procedure), when the random access procedure is performed in two steps (2-step RACH procedure or type-2 random access procedure), steps S13 and S15 may be performed as one UE transmission operation (e.g., an operation of transmitting message A (MsgA) including a PRACH preamble and/or a PUSCH), and steps S14 and S16 may be performed as one BS transmission operation (e.g., an operation of transmitting message B (MsgB) including an RAR and/or contention resolution information)

After the above procedure, the UE may receive a PDCCH and/or a PDSCH from the BS (S17) and transmit a PUSCH and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

### Physical Resources

The BS transmits the relevant signals to the terminal via the downlink channel described herein, and the terminal receives the relevant signals from the BS via the downlink channel described herein.

PDSCH carries downlink data (e.g., DL-SCH Transport Block (DL-SCHTB)), and modulation methods such as Quadrature Phase Shift Keying (QPSK), 16 Quadrature Amplitude Modulation (QAM), 64 QAM, 256 QAM and the like are applied. A codeword is generated by encoding a TB. The PDSCH may carry up to two codewords. Scrambling and modulation mapping are performed for each codeword, and modulation symbols generated from each codeword may be mapped into one or more layers. Each layer is mapped to a resource together with a Demodulation Reference Signal (DMRS), generated as an OFDM symbol signal, and transmitted through a corresponding antenna port.

The PDCCH may deliver downlink control information (DCI), for example, DL data scheduling information, UL data scheduling information, and so on. The PUCCH may deliver uplink control information (UCI), for example, an acknowledgement/negative acknowledgement (ACK/NACK) information for DL data, channel state information (CSI), a scheduling request (SR), and so on.

The PDCCH carries downlink control information (DCI) and is modulated in quadrature phase shift keying (QPSK). One PDCCH includes 1, 2, 4, 8, or 16 control channel elements (CCEs) according to an aggregation level (AL). One CCE includes 6 resource element groups (REGs). One REG is defined by one OFDM symbol by one (P) RB.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The UE acquires DCI delivered on a PDCCH by decoding (so-called blind decoding) a set of PDCCH candidates. A set of PDCCH candidates decoded by a UE are defined as a PDCCH search space set. A search space set may be a common search space (CSS) or a UE-specific search space (USS). The UE may acquire DCI by monitoring PDCCH candidates in one or more search space sets configured by an MIB or higher-layer signaling. Each CORESET configuration is associated with one or more search space sets, and each search space set is associated with one CORESET configuration. One search space set is determined based on the following parameters.

The UE transmits the relevant signals to the BS via the uplink channel described above, and the BS receives the relevant signals from the terminal via the uplink channel described above.

The PUSCH delivers UL data (e.g., a UL-shared channel transport block (UL-SCH TB)) and/or UCI, in cyclic prefix-orthogonal frequency division multiplexing (CP-OFDM) waveforms or discrete Fourier transform-spread-orthogonal division multiplexing (DFT-s-OFDM) waveforms. If the PUSCH is transmitted in DFT-s-OFDM waveforms, the UE transmits the PUSCH by applying transform precoding. For example, if transform precoding is impossible (e.g., transform precoding is disabled), the UE may transmit the PUSCH in CP-OFDM waveforms, and if transform precoding is possible (e.g., transform precoding is enabled), the UE may transmit the PUSCH in CP-OFDM waveforms or DFT-s-OFDM waveforms. The PUSCH transmission may be scheduled dynamically by a UL grant in DCI or semi-statically by higher-layer signaling (e.g., RRC signaling) (and/or layer 1 (L1) signaling (e.g., a PDCCH)) (a configured grant). The PUSCH transmission may be performed in a codebook-based or non-codebook-based manner.

The PUCCH delivers UCI, an HARQ-ACK, and/or an SR and is classified as a short PUCCH or a long PUCCH according to the transmission duration of the PUCCH. Table 7 lists exemplary PUCCH formats.

### QCL (Quasi Co-Located or Quasi Co-Location)

The UE may receive a list of up to M TCI-State configurations to decode a PDSCH according to a detected PDCCH carrying DCI intended for the UE and a given cell. M depends on a UE capability.

Each TCI-State includes a parameter for establishing a QCL relationship between one or two DL RSs and a PDSCH DMRS port. The QCL relationship is established with an RRC parameter qcl-Type1 for a first DL RS and an RRC parameter qcl-Type2 for a second DL RS (if configured).

The QCL type of each DL RS is given by a parameter ‘qcl-Type’ included in QCL-Info, and may have one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is for a specific NZP CSI-RS, corresponding NZP CSI-RS antenna ports may be indicated/configured as QCLed with a specific TRS from the perspective of QCL-Type A and with a specific SSB from the perspective of QCL-Type D. Upon receipt of this indication/configuration, the UE may receive the NZP CSI-RS using a Doppler value and a delay value which are measured in a QCL-TypeA TRS, and apply an Rx beam used to receive a QCL-Type D SSB for reception of the NZP CSI-RS.

### 6G System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

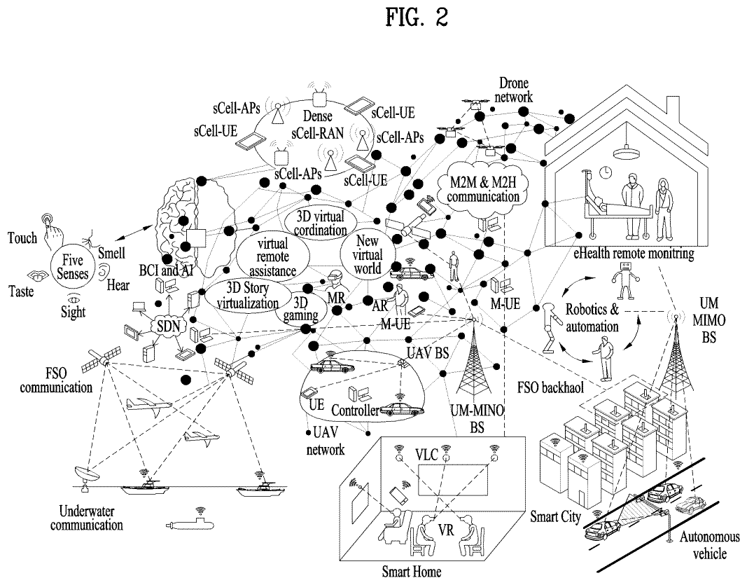

FIG. 2 is a view showing an example of a communication structure providable in a 6G system applicable to the disclosure.

Referring to FIG. 2, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.

Ubiquitous super 3-dimension connectivity: Access to networks and core network functions of drones and very low earth orbit satellites will establish super 3D connection in 6G ubiquitous.

In the new network characteristics of 6G, several general requirements may be as follows.

Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.

Ultra-dense heterogeneous network: Ultra-dense heterogeneous networks will be another important characteristic of the 6G communication system. A multi-tier network composed of heterogeneous networks improves overall QoS and reduces costs.

High-capacity backhaul: Backhaul connection is characterized by a high-capacity backhaul network in order to support high-capacity traffic. A high-speed optical fiber and free space optical (FSO) system may be a possible solution for this problem.

Radar technology integrated with mobile technology: High-precision localization (or location-based service) through communication is one of the functions of the 6G wireless communication system. Accordingly, the radar system will be integrated with the 6G network.

Softwarization and virtualization: Softwarization and virtualization are two important functions which are the bases of a design process in a 5 GB network in order to ensure flexibility, reconfigurability and programmability.

### Embodiments

Embodiments will be described below in more detail based on the above technical ideas. The foregoing description is applicable to the embodiments described below. For example, operations, functions, terms, and so on which are not defined in the embodiments described below may be performed and described based on the foregoing description.

In the description of the embodiments, BS may be understood as a comprehensive term that includes remote radio head (RRH), eNB, gNB, TP, reception point (RP), relay, and so on.

In the description of the embodiments, the BS may be a station and/or a transmitter/receiver, which is responsible for network control and/or data and/or synchronization protocols.

In the description of the embodiments, the phrase greater than/equal to or greater than A may be replaced with equal to or greater than/greater than A.

In the description of the embodiments, the phrase less than/equal to or less than B may be replaced with equal to or less than/less than B.

More specific operations, functions, terms, and so on in an operation according to each embodiment may be performed and described based on the embodiments described later. The operations according to each embodiment are exemplary, and one or more of the operations may be skipped depending on the specifics of each embodiment.

Embodiments will be described below in detail. The embodiments described herein may be combined, in whole or in part, to form another embodiment, unless they contradict each other, which will be clearly understood by those skilled in the art.

Terahertz (THz) wireless communication, which is wireless communication using THz waves having a frequency of approximately 0.1 to 10 THz (1 THz=1012 Hz), may refer to THz-band wireless communication using a very high carrier frequency of 100 GHz or above.

THz waves are located between a radio frequency (RF)/millimeter (mm) band and an infrared (IR) band, and may (i) penetrate non-metallic/non-polarized materials better than visible/IR light, and (ii) have a shorter wavelength than RF/millimeter waves, which allows for high straightness and beam focusing. In addition, the photon energy of the THz waves is only a few meV, harmless to the human body.

A frequency band expected to be used for THz wireless communication may be a D-band (110 GHz to 170 GHz) or an H-band (220 GHz to 325 GHz), in which propagation loss caused by absorption by molecules in the air is small. In addition to the 3GPP, the IEEE 802.15 THz working group is working on standardization of THz wireless communication, and standard documents issued by IEEE 802.15 task groups (TG3d and TG3e) may refine or supplement the description of the disclosure.

THz wireless communication may find its applications in wireless cognition, sensing, imaging, wireless communication, THz navigation, and so on.

THz wireless communication scenarios may be categorized into macro networks, micro networks, and nanoscale networks. In a macro network, THz wireless communication may be applied for vehicle-to-vehicle connectivity and backhaul/fronthaul connectivity. In a micro network, THz wireless communication may be applied to an indoor small cell, fixed point-to-point or multi-point connections such as wireless connections in data centers, and near-field communication such as kiosk downloading.

In beyond 5G communication, scenarios are arising, which seek to use an ultra-wideband in the THz band, including existing spectrums (under 6 GHz, mmWave, and so on). Although the typical THz band ranges 100 GHz to 10 THz, 100 GHz to 300 GHz is considered to be an initial THz region. The THz band differs from existing under 100 GHz band channels in that the number of existing multiple paths is significantly reduced (1 to 3 clusters). Therefore, it is likely to be used in communication scenarios with very low mobility in a line of sight (LoS) environment or an environment using one or two reflectors.

Orbital Angular Momentum (OAM) is a technique that may substitute for conventional up to 2-multiplexing of horizontal/vertical (H/V) polarization. OAM may use N-multiplexing depending on an antenna array application, thereby increasing a communication capacity. For example, beams which may sufficiently satisfy orthogonality among OAM beams may be transmitted simultaneously to maximize a multiplexing gain and allow a receiver to receive the beams according to a corresponding OAM state.

According to an embodiment, there may be provided scrambling seeds and a method of using them, applicable in designing orthogonal sequences which may reduce overhead resulting from beam pairing and/or OAM pairing caused by the overhead limitations of conventional CSI reports and resource indications during beam management (including Tx/Rx OAM state pairing as well as Tx/Rx beam pairing from the perspective of an array in the description of the embodiment) between an OAM-based transmission and reception point (TRP) (or a personal basic service set (PBSS) control point (PCP) terminal) and a UE capable of or incapable of OAM transmission and OAM detection (or a non PBSS control point (NPCP) terminal), and may simplify a beam management procedure, in consideration of a communication environment in a THz band (e.g., 100 GHz to 10 THz).

Embodiments will be described below in detail. The embodiments described herein may be combined in whole or in part into another embodiment, unless they contradict each other, which may be clearly understood by those skilled in the art.

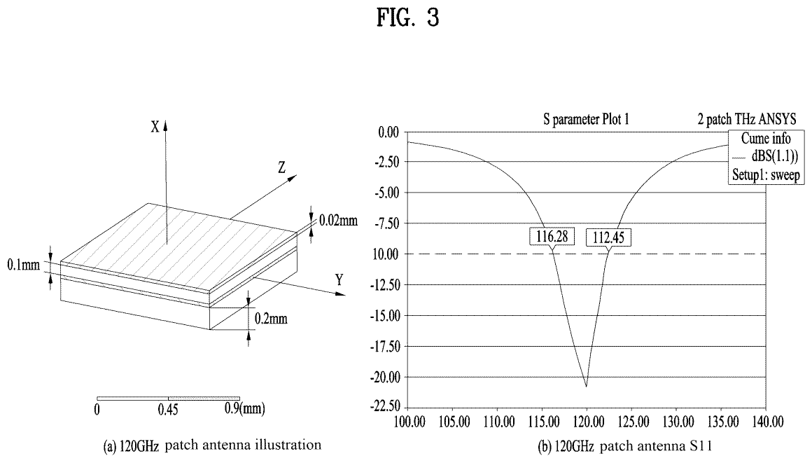

FIG. 3 is a diagram illustrating an exemplary OAM antenna to which an embodiment is applicable.

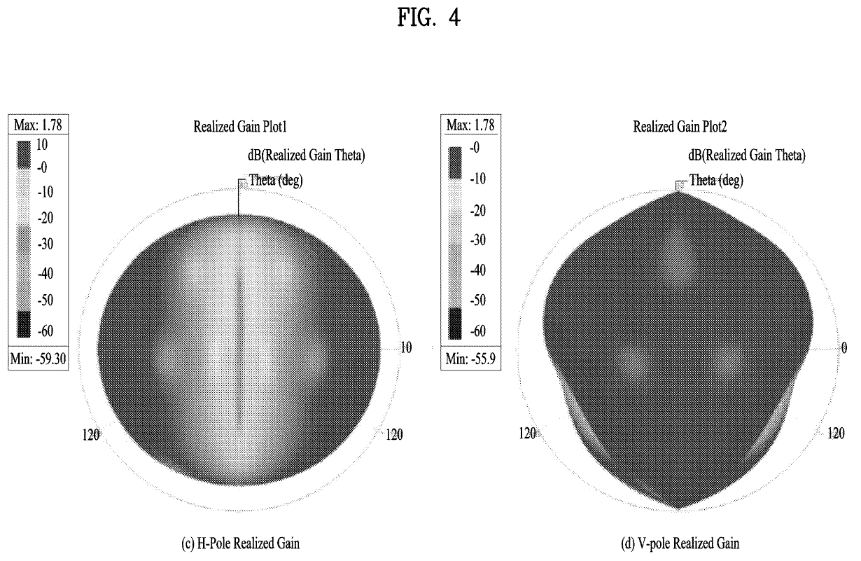

FIG. 4 is a diagram illustrating an exemplary OAM antenna to which an embodiment is applicable.

A 120 GHz patch antenna illustrated in FIG. 3(a) is merely an example of a patch antenna structure to which an embodiment is applicable, to which the embodiment is not limited.

Referring to FIGS. 3(b) to 4(d), the performance of a single antenna (a 120 GHz single patch antenna/v-pole antenna) to which an embodiment is applicable is exhibited as a peal realized gain of 3.4 dBi and a peak V-pole to H-pole realized gain ratio of 1.98 dB.

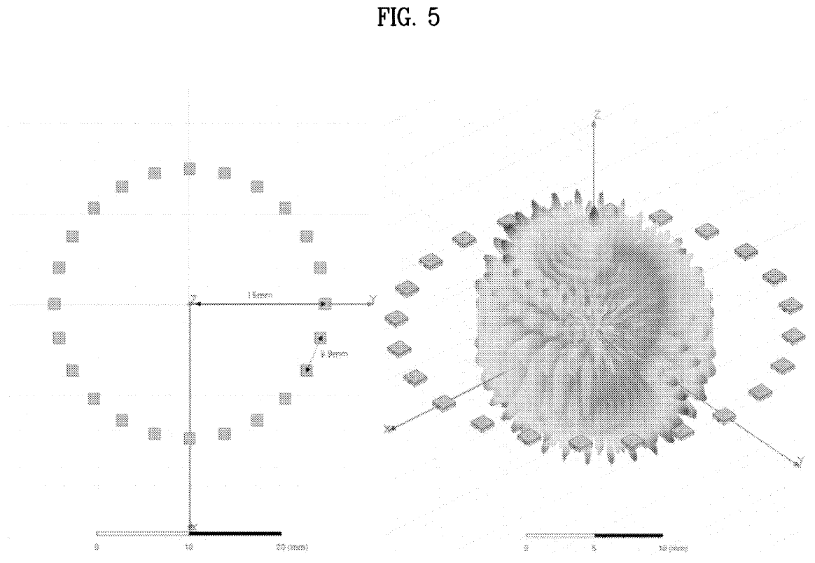

FIG. 5 is a diagram illustrating an exemplary circular array structure to which an embodiment is applicable.

A 1-tier ring 1×24 120 GHz patch array illustrated in FIG. 5 is merely an example of a circular array structure to which an embodiment is applicable, to which the embodiment is not limited.

Referring to FIG. 5, a 1×24 circular array to which an embodiment is applicable may be designed to fix a spin angular momentum (SAM) (to improve the accuracy of OAM state estimation) (s=−1 where s is a spin angular acceleration).

For the antenna array of FIG. 5 to which an embodiment is applicable, the number of OAM states may not exceed 12 according to a maximum number of OAM states formula. To satisfy the condition D<<R, a distance D between antenna elements and a distance R from a coordinate center to the array may be set to 3.9 mm and 15 mm, respectively. An OAM state, may be represented by applying a phase of exp

$$jlk \times \frac{2 π \times 24}{360}$$

to a k^{th} single antenna of the ring array (1×24).

FIG. 6 is a diagram illustrating exemplary OAM with orthogonal beams, to which an embodiment is applicable. In FIG. 6, orthogonal OAM states are l=0 and l=8.

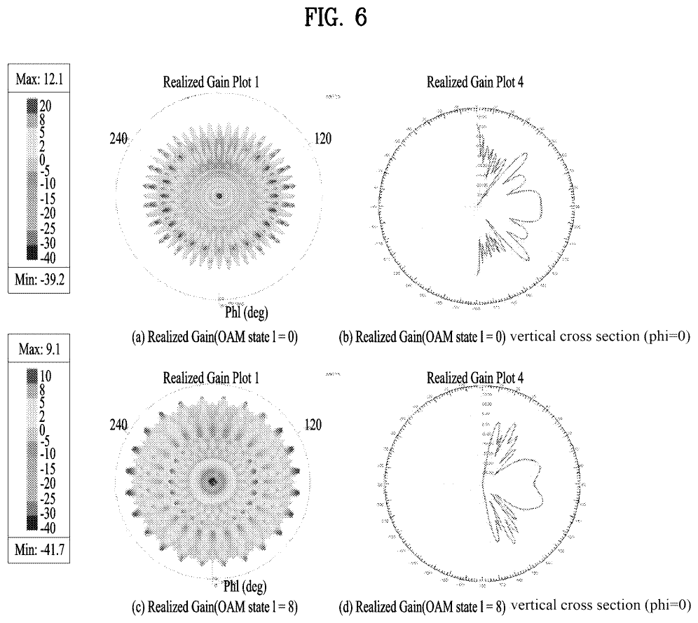

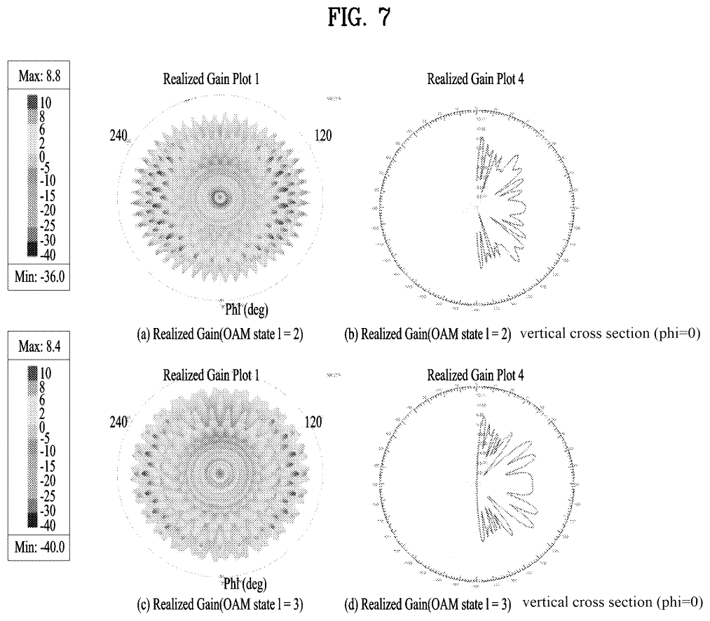

FIG. 7 is a diagram illustrating exemplary OAM with non-orthogonal beams according to an embodiment. In FIG. 7, non-orthogonal OAM states are l=2 and l=3.

Referring to FIGS. 6 and 7, some of beams corresponding to a maximum number of OAM states may be orthogonal or non-orthogonal. Accordingly, the number of orthogonal OAM states for increasing the number of actual streams may be M out of total N OAM states (N>=M). Therefore, an antenna design for OAM that allows an approximate to N may be required.

In an example of applying OAM to a cellular system, the orthogonal OAM states may change all the time depending on channel conditions. Therefore, a method of applying an orthogonal OAM state according to a channel change may be required.

Further, it may be necessary to consider whether a UE is capable of OAM reception with respect to the OAM capability of a BS. The UE may have to have at least an OAM capability equal to or greater than the OAM capability y of the BS, and/or the OAM capability of the BS may be maintained based on a UE with a lowest OAM capability among connected UEs. In addition, a method of applying OAM to UEs other than UEs that do not meet a certain OAM capability reference may be considered.

For the existing NR codebook (Type-1), a method of using V/H polarization through a co-phase factor according to a channel rank during digital beamforming was introduced. That is, for the same beam, the codebook is multiplied by the same co-phase to represent a polarization and increase the number of streams.

However, in an operation for increasing the number of streams through OAM, an OAM state may not be represented by a co-phase. An incremental or decremental phase may need to be applied to each logical port.

The above-described issues may be summarized as follows.
Antenna design suitable for OAM operation (antenna with M orthogonal OAM states out of N OAM states)
Default configuration for OAM operation
Network operation according to OAM operation capability (e.g., problem arising from asymmetry between transmission and reception OAM states)
Codebook for applying OAM
Feedback method and applying method, for OAM
Need to check whether beamforming is possible when applying OAM or whether OAM is available after applying beamforming

According to an embodiment, when Tx/Rx beamforming pairing and Tx/Rx OAM state pairing are considered, a configuration for a scrambling seed available for generating a sequence applicable during beam management, and a procedure for effective beam management using the same may be provided.

According to an embodiment, excessive overhead of Tx/Rx beams, OAM state indications, and their related CSI reporting, which are used for Tx/Rx beam forming pairing and Tx/Rx OAM state pairing, may be reduced by using scrambling seed information.

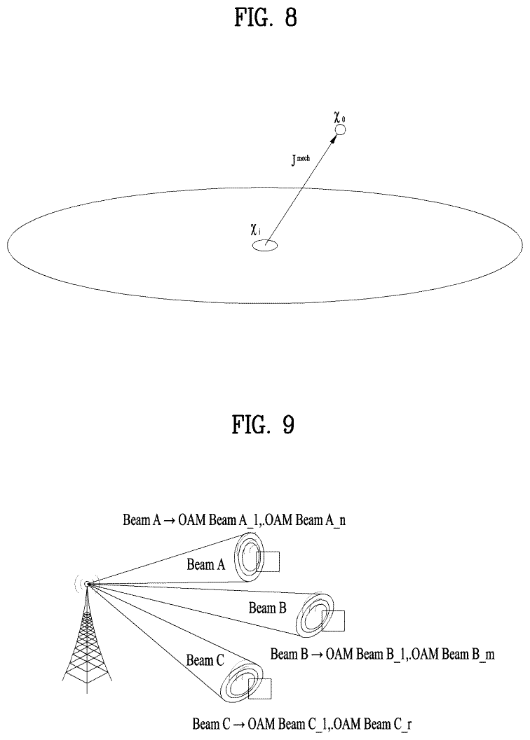

FIG. 8 is a diagram illustrating exemplary angular momentum to which an embodiment is applicable.

Electromagnetic radiation may deliver both energy and momentum. The momentum, which is a physical quantity representing the motion of particles by radio waves, may be a physical quantity of particles in linear and angular motions.

Linear momentum Pᵢ^{mech} of nonrelativistic, spinless, and classical particles may have angular momentum. Angular momentum (linear) J^{mech} with respect to a radiation point xᵢ may be given by the following equation.

$${J}^{m e c h} = {\sum }_{i} ( {x}_{i} - {x}_{0} ) \times {P}_{i}^{m e c h}$$

Referring to FIG. 8, the angular momentum of any point x₀ with respect to a radiation point (radiation source) may be given by the above equation.

Total angular momentum may be determined by the following equation.

$${J}^{t o t} = {J}^{m e c h} + {J}^{E M}$$

J^{EM} may be the sum of spin angular momentum (SAM) S^{EM} and OAM L^{EM}.

$${J}^{E M} = {S}^{E M} + {L}^{E M} = \int ( x - {x}_{0} ) \times ( E \times B ) {d}^{3} x$$

An orthogonal beam and an energy field distribution (or beam shape) may vary depending on OAM states (or OAM modes).

For example, an OAM state may have an OAM component

$${J}_{z}^{E M} = \frac{j M}{w}$$

with respect to a beam direction (e.g., z direction). For example, the OAM state may be affected by a vertical phase of e^{jlφ} (H=field energy and w=frequency).

To verify the applicability of OAM, an equidistant circular array antenna (with strong right-hand circular polarization) has been considered. When J_{z}^{EM} (this element may be estimated using a transmission and reception distance x₀, E and H fields, and/or a pointing vector value by a receiver or may be provided by a transmitter) is predictable and received energy M is measurable, an OAM state \hat{l} (an estimate of the OAM state) may be estimated reversely (right-hand: s=−1 and left-hand: s=1)

For an example of a comparison between the estimated OAM state \hat{l} and an actual OAM state l, Table 2 may be referred to (a right-hand circular polarized beam (s=1) formed by a ring array of 10 crossed dipoles, a distance between arrays D=λ, 0.1λ over perfect ground, and a polar angle θ=0). It may be noted from Table 2 that an OAM state may be estimated by measuring received energy.

TABLE 2

| l | s | j = l + s | $\hat{J} = \frac{w \cdot {J}_{z}^{EM}}{M}$ | \hat{l} |
|---|---|---|---|---|
| 0 | −1 | −1 | −1.019 | −0.019 |
| 1 | −1 | 0 | −0.022 | 0.978 |
| 2 | −1 | 1 | 0.971 | 1.971 |
| 3 | −1 | 2 | 1.81 | 2.81 |

Basically, the total number N of OA states which may be generated may be equal to the number of antennas on a ring perpendicular to a beam direction/2 (however, in the case of a 1-tier ring array, see FIG. 5.) The number of estimable OAM states may have the following relationship.

$$\vert \hat{l} \vert < total number of antenna elements \times \frac{π R}{D}$$

Therefore, for an OAM transmission that maximizes the number of estimable OAM states, the condition R>>D needs to be satisfied (where R is the distance from the center to the array, and D is the distance between two adjacent antenna elements).

FIG. 9 is exemplary OAM communication according to an embodiment. FIG. 9 may illustrate a relationship between beamforming and/or hybrid beamforming and OAM.

In beyond 5G communication, scenarios are arising, which seek to use an ultra-wideband in the THz band, including existing spectrums (under 6 GHz, mmWave, and so on). Although the typical THz band ranges 100 GHz to 10 THz, 100 GHz to 300 GHz is considered to be an initial THz region. The THz band differs from existing under 100 GHz band channels in that the number of existing multiple paths is significantly reduced (1 to 3 clusters). Therefore, it is likely to be used in communication scenarios with very low mobility in a LoS environment or an environment using one or two reflectors.

OAM is a technique that may substitute for conventional up to 2-multiplexing of horizontal/vertical (H/V) polarization. OAM may use N-multiplexing depending on an antenna array application, thereby increasing a communication capacity. For example, beams which may sufficiently satisfy orthogonality among OAM beams may be transmitted simultaneously to maximize a multiplexing gain and allow a receiver to receive the beams according to a corresponding OAM state.

Referring to FIG. 9, from the perspective of MU-MIMO, an environment may be generated, in which additional multiplexing and diversity gains may be obtained through an OAM operation from the perspective of a single UE after a beamforming operation (e.g., hybrid beamforming).

In an embodiment, for OAM multiplexing/diversity, an OAM resource configuration and/or an OAM reporting configuration corresponding to the OAM resource configuration may be provided in consideration of a communication environment in a THz band (e.g., 100 GHz to 10 THz).

According to an embodiment, an operational method (2-step CSI signaling) for an OAM operation after MU-MIMO reference beamforming using an OAM resource configuration and/or an OAM reporting configuration may be provided.

According to an embodiment, a method of reducing reporting overhead for an OAM operation may be provided.

According to an embodiment, a method of efficiently performing OAM-based multiplexing and diversity using an existing beam indication and a related reporting method may be provided.

In the description of an embodiment, a BS may be a station and/or a transmitter/receiver, which is responsible for network control and/or data and/or synchronization protocols.

While an embodiment is described in the context of a frequency band having a channel rank of 1, this is for illustrative purposes only, not limiting the embodiment. Accordingly, the embodiment may also be applied to a frequency band having a channel rank of 2 or higher.

In the description of an embodiment, an OAM resource may refer to a resource for measuring an OAM state. For example, one or more OAM states may be measured and/or estimated through one OAM resource.

Unless specified otherwise, a set of OAM reference resources and a set of OAM resources are interchangeable, and an OAM reference resource and an OAM resource are interchangeable.

### Proposal 1. OAM Reference Resource Set/OAM Resource Configuration

According to an embodiment, an OAM reference resource set may include K1 CSI-RS resources and K2 synchronization signal/physical broadcast channel (SS/PBCH) block (SSB) resources and/or K3 OAM reference resources. According to an embodiment, the OAM reference resource set may be configured through an OAM resource configuration.

And/or, according to an embodiment, OAM resources may be partially included in one CSI-RS resource set. According to an embodiment, K1 CSI-RS resources and K2 OAM resources may form one CSI-RS resource set.

According to an embodiment, an OAM resource set may be configured in a DL/UL bandwidth part (BWP) through a DL/UL BWP resource configuration as in NR.

### 1) Periodic Allocation

According to an embodiment, the periodicity of an OAM reference resource set may be replaced by a CSI-RS periodicity T_{CSI-RS} and/or configured as T_{OAM-RS} through the RRC. According to an embodiment, the CSI-RS periodicity may be used as the periodicity of the OAM reference resource set, and/or the periodicity of the OAM reference resource set may be configured separately.

According to an embodiment, an OAM transmission slot offset T_{OAM-Offset} may be a transmission slot offset T_{Offset} of CSI-RS resources and/or configured independently by a higher layer.

### 2) Semi-Persistent Allocation

According to an embodiment, OAM trigger signaling may refer to downlink control information (DCI) for activation/deactivation of an OAM state measurement.

According to an embodiment, when OAM trigger is enabled (activated), an OAM state may be measured through OAM resources.

According to an embodiment, when OAM trigger is disabled (deactivated), the BS may not configure OAM resources and/or the UE may consider configured OAM resources to be CSI-RS resources.

For example, when an OAM resource exists in a CSI-RS resource set at the time of disabling OAM trigger, the UE may ignore the OAM resource and/or consider the OAM resource to be a CSI-RS resource.

For example, when the BS receives a report of a CSI resource indicator (CRI) indicating OAM resources from the UE during a disable (deactivation) period of OAM trigger, the BS may ignore the CRI and/or understand the CRI as a channel measurement ID for a corresponding CSI port.

### 3) Aperiodic Allocation

According to an embodiment, when multiple OAM resources and multiple OAM resource sets are configured, there may be DCI that triggers a specific OAM resource and/or a specific OAM resource set.

For example, when there are 4 OAM resource set configurations, 2 bits are assigned to an OAM resource field in the DCI, and the value of the field is set to, for example, 11, this may indicate that a fourth OAM resource set is triggered.

It may be generalized that when there are NOAM resource set configurations, the OAM resource field in the DCI may be [log₂ N] bits according to an embodiment. According to an embodiment, the values of the OAM resource field in the DCI may sequentially indicate triggering of the N OAM resource set configurations in ascending order.

### Proposal 2. OAM Reporting Configuration

According to an embodiment, an OAM reporting configuration may be a reporting configuration including a combination of a CRI, channel quality information (CQI), a rank indicator (RI), layer 1-reference signal received power (L1-RSRP), an L1-signal to noise ratio (L1-SINR), an L1-reference signal received quality (L1-RSRQ), a layer indicator (LI), and so on, which are based on an OAM state estimated from a certain OAM resource set and/or resource, and may be configured on a BWP basis or on a component carrier (CC) basis.

According to an embodiment, the OAM resource configuration and the OAM reporting configuration may be for facilitating enabling/disabling an OAM operation.

FIG. 10 illustrates an exemplary OAM transmission and reporting method for OAM multiplexing/diversity according to an embodiment.

Referring to FIG. 10, according to an embodiment, a BS may transmit information about a CSI-RS resource set and/or a CSI-RS resource, and a UE may receive the information. According to an embodiment, the UE may report CSI (including a CRI, a RI, and so on) in response to the information, and the BS may receive the CSI report. According to an embodiment, the BS may transmit information about an OAM resource set and/or an OAM resource, main beam information (CRI), and OAM trigger information, and the UE may receive the information. In an embodiment, the UE may report OAM state information in response to the information, and the BS may receive the OAM state information. For example, the OAM state information may include one or more of a CRI, CQI, an LI, L1-RSRP, an L1-SINR, an L1-RSRQ, and a received signal strength indicator (RSSI).

According to an embodiment, the UE may first measure CSI by receiving a CSI resource set and/or a CSI resource configured through a CSI resource configuration. According to an embodiment, the UE may report best CSI (based on a CQI, L1-RSRP, an L1-SINR, an RSSI, or the like). According to an embodiment, the BS may transmit an OAM resource set and/or an OAM resource based on an OAM resource configuration to the UE by a beam corresponding to the received CRI and/or LI, and upon receipt of the OAM resource set and/or the OAM resource, the UE may measure and/or estimate an OAM state through an OAM operation.

According to an embodiment, the BS may transmit Main beam info. to the UE. According to an embodiment, the Main beam info. may be a field including the best of previously reported CRIs (based on a CQI, L1-RSRP, an L1-SINR, L1-RSRQ, or an RSSI) or one of N best CRIs.

According to an embodiment, the UE may measure and estimate an OAM state through a received beam corresponding to and/or quasi co-located (QCLed) with the CRI.

And/or, according to an embodiment, the BS may simply transmit an OAM trigger field to the UE, and the UE may measure and estimate an OAM state based on a UE-received beam corresponding to and/or QCLed with the best of already measured CRIs or one of N best beams.

And/or, according to an embodiment, the UE may measure and estimate an OAM state based on a received beam corresponding to and/or QCLed with an LI in a previously transmitted feedback.

According to an embodiment, the UE may transmit a feedback to the BS using a UL data channel (PUSCH) and/or a PUCCH according to an OAM reporting configuration based on the OAM state measured in the OAM resource set and/or the OAM resource.

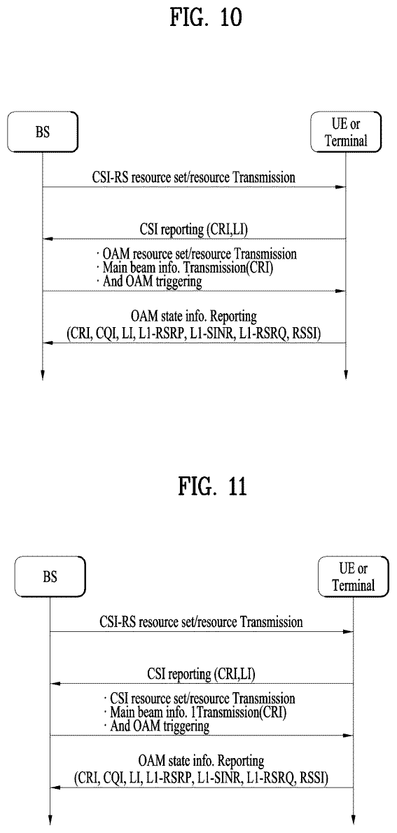

FIG. 11 illustrates an exemplary OAM transmission and reporting method for OAM multiplexing/diversity according to an embodiment. FIG. 11 may be an example without an OAM resource configuration and an OAM reporting configuration.

Referring to FIG. 11, according to an embodiment, a BS may transmit information about a CSI-RS resource set and/or a CSI-RS resource, and a UE may receive the information. According to an embodiment, the UE may report CSI (including a CRI, a RI, and so on) in response to the information, and the BS may receive the CSI report. According to an embodiment, the BS may transmit information about a CSI resource set and/or a CSI-RS resource, main beam information (CRI), and OAM trigger information, and the UE may receive the information. According to an embodiment, the UE may report OAM state information in response to the information, and the BS may receive the OAM state information. For example, the OAM state information may include one or more of a CRI, CQI, an LI, L1-RSRP, an L1-SINR, an L1-RSRQ, and an RSSI.

According to an embodiment, in the absence of an OAM resource configuration and an OAM reporting configuration, the OAM transmission method as illustrated in FIG. 11 may be considered. According to an embodiment, upon receipt of main beam information or an OAM trigger field after CSI reporting, the UE may measure and estimate an OAM state in the CSI resource set and/or the CSI-S resource by a received beam QCLed with a CRI associated with the main beam information and OAM trigger, and perform corresponding CRI or CSI reporting.

According to an embodiment, the BS may consider received CRI and/or CSI report information for the CSI resource set/resource corresponding to OAM trigger to be information about an OAM state. According to an embodiment, an OAM operation and a hybrid beamforming operation may be distinguished from each other by OAM triggering signaling, and OAM trigger information and/or main beam information may be transmitted accordingly.

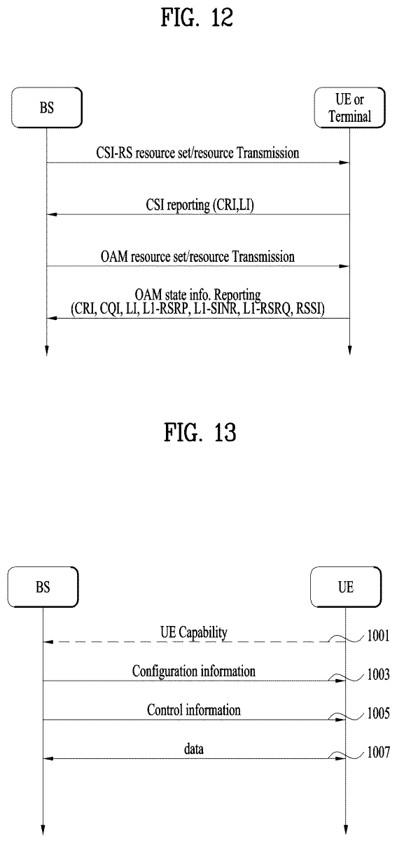

FIG. 12 illustrates an exemplary OAM transmission and reporting method for OAM multiplexing/diversity according to an embodiment. FIG. 12 may be an example with an OAM resource configuration and an OAM reporting configuration.

Referring to FIG. 12, according to an embodiment, a BS may transmit information about a CSI-RS resource set and/or a CSI-RS resource, and a UE may receive the information. According to an embodiment, the UE may report CSI (including a CRI, a RI, and so on) in response to the information, and the BS may receive the CSI report. According to an embodiment, the BS may transmit information about an OAM resource set and/or an OAM resource, and the UE may receive the information. According to an embodiment, the UE may report OAM state information in response to the information, and the BS may receive the OAM state information. For example, the OAM state information may include one or more of a CRI, CQI, an LI, L1-RSRP, an L1-SINR, an L1-RSRQ, and an RSSI.

According to an embodiment, when an OAM resource configuration and an OAM reporting configuration are configured, and the UE receives an OAM resource set and/or an OAM resource, the UE may measure a reception OAM state for an OAM operation of the BS, based on a UE-received beam QCLed with a recent reported CRI, and report information about the OAM state (e.g., a CRI, CQI, an LI, L1-RSRP, an L1-SINR, an L1-RSRQ, an RSSI, and so on) to the BS in response to the OAM reporting configuration. For example, in the presence of an OAM triggering configuration and an OAM reporting configuration, transmission/reception of OAM trigger information and/or main beam information may not be required.

FIG. 13 is a simplified diagram illustrating a method of operating a UE and a network node according to an embodiment.

An example of signaling between a BS and a UE for the above-described proposed methods (e.g., Proposal 1/Proposal 2) may be as illustrated in FIG. 13. FIG. 13 is for illustrative purposes only, not limiting the scope of the embodiments. The BS may refer to an object that performs data transmission and reception with the UE. For example, the BS may conceptually cover one or more transmission points (TPs), one or more transmission and reception points (TRPs), and the like (wherein the UE/BS is an example only and may be replaced by various other devices as described later). Further, a TP and/or a TRP may include a BS panel, a transmission and reception unit, and the like. Further, some of the steps described with reference to FIG. 13 may be combined or skipped.

According to an embodiment, the UE may transmit UE capability information to the BS (1301).

For example, the UE capability information may include information (e.g., information about a transmission mode supported by the UE) about whether the UE is capable of performing the methods described in the proposed methods (e.g., Proposal 1/Proposal 2) described above. When the UE capability information is predefined/agreed, this step may be skipped.

According to an embodiment, the UE may receive configuration information from the BS (1303).

For example, the configuration information may include system information (SI) and/or scheduling information and/or a CSI-related configuration (e.g., a CSI reporting configuration/CSI-RS resource configuration) and/or PUCCH/PUSCH-Config (e.g., TS 38.331 PUCCH/PUSCH Config) and/or PDCCH/PDSCH-Config (e.g., TS 38.331 PDCCH/PDSCH Config). For example, the configuration information may be received through a higher layer (e.g., RRC/MAC-CE).

The CSI-related configuration information may include at least one of CSI-interference management (CSI-IM) resource-related information, CSI measurement configuration-related information, CSI resource configuration-related information, CSI-RS resource-related information, or CSI report configuration-related information.
i) The CSI-IM resource-related information may include CSI-IM resource information, CSI-IM resource set information, and so on. A CSI-IM resource set is identified by a CSI-IM resource set ID, and one CSI-IM resource set includes at least one CSI-IM resource. Each CSI-IM resource is identified by a CSI-IM resource ID.
ii) The CSI resource configuration-related information may be represented as a CSI-ResourceConfig IE. The CSI resource configuration-related information defines a group including at least one of a non-zero power (NZP) CSI-RS resource set, a CSI-IM resource set, or a CSI-SSB resource set. That is, the CSI resource configuration-related information may include a CSI-RS resource set list, and the CSI-RS resource set list may include at least one of an NZP CSI-RS resource set list, a CSI-IM resource set list, or a CSI-SSB resource set list. A CSI-RS resource set is identified by a CSI-RS resource set ID, and one CSI-RS resource set includes at least one CSI-RS resource. Each CSI-RS resource is identified by a CSI-RS resource ID.

As described in Table 3, a parameter indicating the purpose of a CSI-RS (e.g., a ‘repetition’ parameter for BM or a ‘trs-Info’ parameter for tracking) may be configured for each NZP CSI-RS resource set.

Table 3 illustrates an example of the NZP CSI-RS resource set IE.

```
TABLE 3
  -- ASN1START
  -- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |
| | OPTIONAL, |
| aperiodicTriggeringOffset | INTEGER(0..4) |
| | OPTIONAL, -- Need S |
| trs-Info | ENUMERATED {true} |
| | OPTIONAL, -- Need R |

```
    ...
  }
  -- TAG-NZP-CSI-RS-RESOURCESET-STOP
  -- ASN1STOP
```

The higher-layer parameter, repetition corresponds to an L1 parameter, ‘CSI-RS-ResourceRep’.
iii) The CSI report configuration-related information includes a report configuration type parameter reportConfigType indicating a time domain behavior and a report quantity parameter reportQuantity indicating a CSI-related quantity to be reported. The time domain behavior may be periodic, aperiodic, or semi-persistent.

The CSI report configuration-related information may be represented as a CSI-ReportConfig IE, and Table 4 below illustrates an example of the CSI-ReportConfig IE.

```
TABLE 4
  -- ASN1START
  -- TAG-CSI-RESOURCECONFIG-START
```

| | |
|---|---|
| CSI-ReportConfig ::= | SEQUENCE { |
| reportConfigId | CSI-ReportConfigId, |
| carrier | ServCellIndex |

OPTIONAL, -- Need S

| resourcesForChannelMeasurement | CSI-ResourceConfigId, | |
|---|---|---|
| csi-IM-ResourcesForInterference | CSI-ResourceConfigId | OPTIONAL, |

-- Need R

| | | |
|---|---|---|
| nzp-CSI-RS-ResourcesForInterference | CSI-ResourceConfigId | OPTIONAL, |

-- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {sl5, sl10, sl20, |

sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

Allocations)) OF INTEGER(0..32)

}
},

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL
},

| | |
|---|---|
| cri-RI-CQI | NULL, |
| cri-RSRP | NULL, |
| ssb-Index-RSRP | NULL, |
| cri-RI-LI-PMI-CQI | NULL |

},

For example, as described in the above proposed methods (e.g., Proposal 1/Proposal 2), the configuration information may include OAM state-related information of the BS. For example, the OAM state-related information may include a total number of OAM states of the BS/a maximum number of orthogonal OAM states/a set of OAM states/a subset of OAM states/information related to a ring array of the BS (e.g., the number of ring arrays/the number of ring array ports)/transmission mode-related information.

According to an embodiment, the UE may receive control information from the BS (1305). For example, the control information may be received through a control channel (e.g., PDCCH). In an example, the control information may be DCI. For example, the OAM state-related information described above may be configured through the DCI.

According to an embodiment, the UE may transmit and receive data to and from the BS (1307). For example, when the data is DL data, the UE may receive the data from the BS through a DL channel (e.g., PDCCH/PDSCH). For example, when the data is UL data, the UE may transmit the data to the BS through a UL channel (e.g., PUCCH/PUSCH). For example, the data may be scheduled based on the configuration information/control information received in step 1303/1305.

For example, the data may include information described in the above-described proposed methods (e.g., Proposal 1/Proposal 2). For example, the data may include one or more of the number of OAM states detectable by the UE out of the number of OAM states configured for the UE/an OAM subset/an OAM set/an OAM state index. For example, the data may include feedback information of the UE for a TM configuration of the BS.

For example, the UE may receive a CSI-related RS (e.g., CSI-RS) from the BS, measure the RS, and report CSI to the BS. In this case, the data may include a CSI report. For example, the CSI report may include a precoding matrix indicator (PMI)/RI, and the PMI may be calculated based on the codebook described before in Proposal 2.

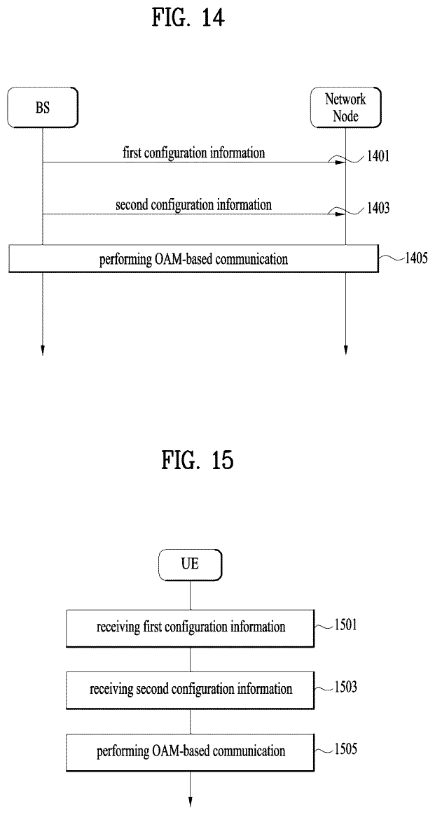

FIG. 14 is a simplified diagram illustrating a method of operating a UE and a network node according to an embodiment.

FIG. 15 is a flowchart illustrating a method of operating a UE according to an embodiment.

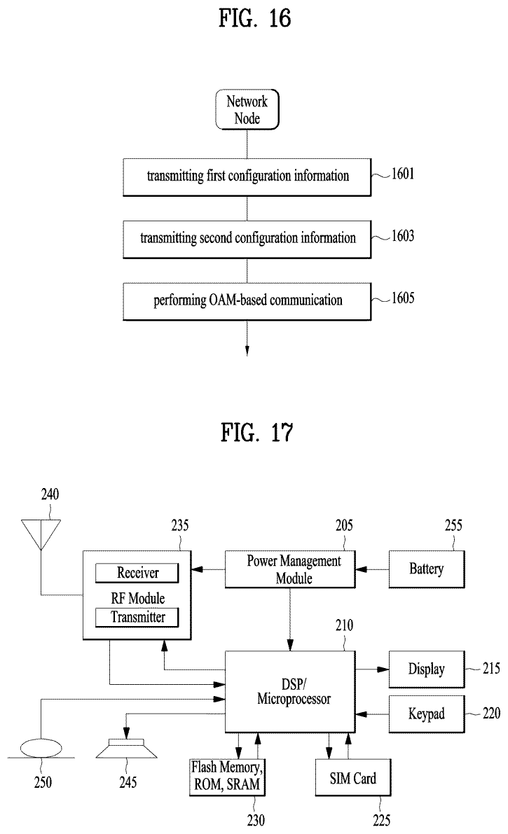

FIG. 16 is a flowchart illustrating a method of operating a network node according to an embodiment. For example, the network node may be a TP and/or a BS and/or a cell and/or another UE and/or any other device that performs the same operation.

Referring to FIGS. 14 to 16, in operations 1401, 1501, and 1601 according to an embodiment, the network node may transmit first configuration information related to a CSI-RS, and the UE may receive the first configuration information.

According to an embodiment, the first configuration information may include at least one of information related to one or more CSI-RS resources for the CSI-RS or information related to a CSI-RS resource set including the one or more CSI-RS resources.

In operations 1403, 1503, and 1603 according to an embodiment, the network node may transmit second configuration information related to OAM, and the UE may receive the second configuration information.

According to an embodiment, the second configuration information may include at least one of information related to one or more OAM resources or information related to an OAM resource set including the OAM resources.

In operations 1405, 1505, and 1605, according to an embodiment, the UE and the network may perform an operation related to OAM-based communication based on the second configuration information.

According to an embodiment, the one or more OAM resources may be for measuring an OAM state.

More specific operations of the UE and/or the network node according to the above-described embodiment may be described and performed based on the description of the preceding sections 1 to 3.

It will be appreciated that any of examples of the above-described proposed methods may also be included as one of the embodiments and thus considered to be a kind of proposed method. Further, the above-described proposed methods may be implemented independently, and some of them may also be implemented as a combination (or merged). It may be regulated that the BS indicates to the UE whether to apply the proposed methods (or information about rules for the proposed methods) through a predefined signal (e.g., a physical-layer signal or a higher-layer signal).

### 4. Exemplary Configurations of Devices Implementing Embodiment of the Disclosure

4.1. Exemplary Configurations of Devices to which Embodiment of the Disclosure is Applied

FIG. 17 is a diagram illustrating devices that implement various embodiments of the disclosure.

The devices illustrated in FIG. 17 may be a UE and/or a BS (e.g., an eNB or gNB, or a TP) adapted to perform the above-descried mechanism, or any devices that perform the same operations.

Referring to FIG. 17, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 17 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 17 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor included in a UE (or a communication device included in the UE) and a BE (or a communication device included in the BS) according to various embodiments of the disclosure may operate as follows, while controlling a memory.

In an embodiment, a UE or a BS may include: at least one transceiver; at least one memory; and at least one processor coupled to the transceiver and the memory. The memory may store instructions causing the at least one processor to perform the following operations.

A communication device included in the UE or the BS may be configured to include the at least one processor and the at least one memory. The communication device may be configured to include the at least one transceiver or to be coupled to the at least one transceiver without including the at least one transceiver.

A TP and/or a BS and/or a cell and/or any device that performs the same operation may be called a network node.

According to an embodiment, the at least one processor included in the UE (or the at least one processor of the communication device included in the UE) may be configured to receive first configuration information related to a CSI-RS.

According to an embodiment, the first configuration information may include at least one of information related to one or more CSI-RS resources for the CSI-RS or information related to a CSI-RS resource set including the one or more CSI-RS resources.

According to an embodiment, the at least one processor included in the UE may be configured to receive second configuration information related to OAM.

According to an embodiment, the second configuration information may include at least one of information related to one or more OAM resources or information related to an OAM resource set including the OAM resources.

According to an embodiment, the at least one processor included in the UE may be configured to perform an operation related to OAM-based communication based on the second configuration information.

According to an embodiment, the one or more OAM resources may be for measuring an OAM state.

According to an embodiment, the at least one processor included in the network node (or the at least one processor of the communication device included in the network node) may be configured to transmit first configuration information related to a CSI-RS.

According to an embodiment, the first configuration information may include at least one of information related to one or more CSI-RS resources for the CSI-RS or information related to a CSI-RS resource set including the one or more CSI-RS resources.

According to an embodiment, the at least one processor included in the network node may be configured to transmit second configuration information related to OAM.

According to an embodiment, the second configuration information may include at least one of information related to one or more OAM resources or information related to an OAM resource set including the OAM resources.

According to an embodiment, the at least one processor included in the network node may be configured to perform an operation related to OAM-based communication based on the second configuration information.

More specific operations of the processor included in the UE and/or the network node according to the above-described embodiment may be described and performed based on the contents of the above-described sections 1 to 3.

Embodiments may be implemented in combination/conjunction with each other unless they contradict each other. For example, a UE and/or a network node (a processor included in the UE and/or the network node) according to an embodiment may perform combined/merged operations of the embodiments of the above-described sections 1 to 3, unless they contradict each other.

### 4.2. Example of Communication System to Embodiment of the Disclosure is Applied

In the present specification, various embodiments of the disclosure have been mainly described in relation to data transmission and reception between a BS and a UE in a wireless communication system. However, various embodiments of the disclosure are not limited thereto. For example, various embodiments of the disclosure may also relate to the following technical configurations.

The various descriptions, functions, procedures, proposals, methods, and/or operational flowcharts of the various embodiments of the disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

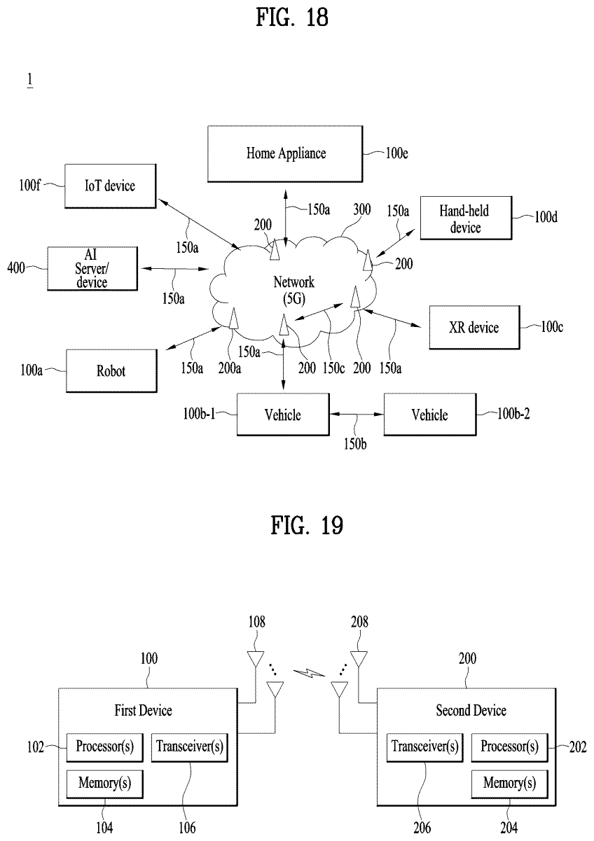

FIG. 18 illustrates an exemplary communication system to which various embodiments of the disclosure are applied.

Referring to FIG. 18, a communication system 1 applied to the various embodiments of the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the various embodiments of the disclosure.

Example of Wireless Devices to which Embodiment of the Disclosure is Applied

FIG. 19 illustrates exemplary wireless devices to which various embodiments of the disclosure are applicable.

Referring to FIG. 19, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 18.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the various embodiments of the disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the various embodiments of the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to various embodiments of the disclosure, one or more memories (e.g., 104 or 204) may store instructions or programs which, when executed, cause one or more processors operably coupled to the one or more memories to perform operations according to various embodiments or implementations of the disclosure.

According to various embodiments of the disclosure, a computer-readable storage medium may store one or more instructions or computer programs which, when executed by one or more processors, cause the one or more processors to perform operations according to various embodiments or implementations of the disclosure.

According to various embodiments of the disclosure, a processing device or apparatus may include one or more processors and one or more computer memories connected to the one or more processors. The one or more computer memories may store instructions or programs which, when executed, cause the one or more processors operably coupled to the one or more memories to perform operations according to various embodiments or implementations of the disclosure.

Example of Using Wireless Devices to which Embodiment of the Disclosure is Applied

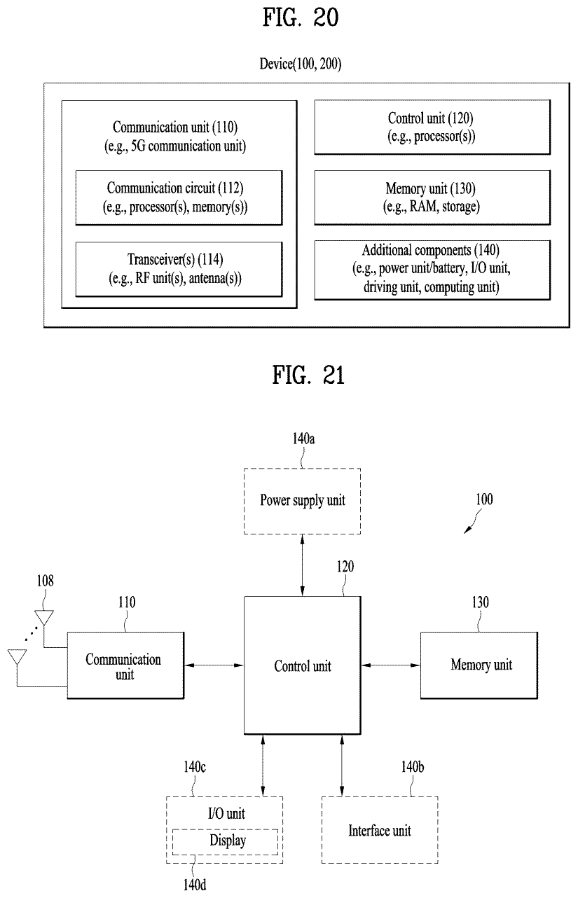

FIG. 20 illustrates other exemplary wireless devices to which various embodiments of the disclosure are applied. The wireless devices may be implemented in various forms according to a use case/service (see FIG. 18).

Referring to FIG. 20, wireless devices 100 and 200 may correspond to the wireless devices 100 and 200 of FIG. 18 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 18. For example, the transceiver(s) 114 may include the one or more transceivers 106 and 206 and/or the one or more antennas 108 and 208 of FIG. 18. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. W1), the vehicles (100b-1 and 100b-2 of FIG. W1), the XR device (100c of FIG. W1), the hand-held device (100d of FIG. W1), the home appliance (100e of FIG. W1), the IoT device (100f of FIG. W1), a digital broadcast terminal, a hologram device, a public safety device, an MTC device, a medicine device, a fintech device (or a finance device), a security device, a climate/environment device, the AI server/device (400 of FIG. W1), the BSs (200 of FIG. W1), a network node, etc. The wireless device may be used in a mobile or fixed place according to a use-example/service.

In FIG. 20, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 20 will be described in detail with reference to the drawings.

Example of Portable Device to which Embodiment of the Disclosure is Applied

FIG. 21 illustrates an exemplary portable device to which various embodiments of the disclosure are applied. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 21, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. X3, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Example of Vehicle or Autonomous Driving Vehicle to which Embodiment of the Disclosure is Applied

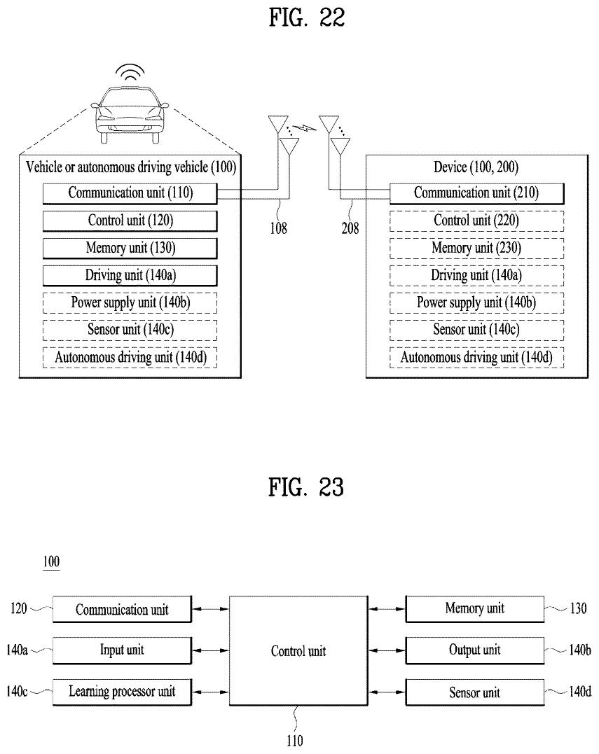

FIG. 22 illustrates an exemplary vehicle or autonomous driving vehicle to which various embodiments of the disclosure. The vehicle or autonomous driving vehicle may be implemented as a mobile robot, a car, a train, a manned/unmanned aerial vehicle (AV), a ship, or the like.

Referring to FIG. 22, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. X3, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

FIG. 23 is a view showing an example of artificial intelligence (AI) device applicable to the disclosure.

the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

The AI device 100 may include a communication unit (transceiver) 910, a control unit (controller) 120, a memory unit (memory) 130, an input/output unit 140a/140b, a leaning processor unit (learning processor) 140 c and a sensor unit 140 d. The blocks 110 to 130/140 a to 140 d may correspond to the blocks 110 to 130/140 of FIG. 20, respectively.

The communication unit 110 may transmit and receive wired/wireless signals (e.g., sensor information, user input, learning models, control signals, etc.) to and from external devices such as another AI device (e.g., FIG. 18, 100 x, 200 or 400) or the AI server (200) using wired/wireless communication technology. To this end, the communication unit 110 may transmit information in the memory unit 130 to an external device or transfer a signal received from the external device to the memory unit 130.

The control unit 120 may determine at least one executable operation of the AI device 100 based on information determined or generated using a data analysis algorithm or a machine learning algorithm. In addition, the control unit 120 may control the components of the AI device 100 to perform the determined operation. For example, the control unit 120 may request, search for, receive or utilize the data of the learning processor unit 140 c or the memory unit 130, and control the components of the AI device 100 to perform predicted operation or operation, which is determined to be desirable, of at least one executable operation. In addition, the control unit 120 may collect history information including operation of the AI device 100 or user's feedback on the operation and store the history information in the memory unit 130 or the learning processor unit 140 c or transmit the history information to the AI server (FIG. 18, 400). The collected history information may be used to update a learning model.

The memory unit 130 may store data supporting various functions of the AI device 100. For example, the memory unit 130 may store data obtained from the input unit 140 a, data obtained from the communication unit 110, output data of the learning processor unit 140c, and data obtained from the sensing unit 140. In addition, the memory unit 130 may store control information and/or software code necessary to operate/execute the control unit 120.

The input unit 140a may acquire various types of data from the outside of the AI device 100. For example, the input unit 140a may acquire learning data for model learning, input data, to which the learning model will be applied, etc. The input unit 140a may include a camera, a microphone and/or a user input unit. The output unit 140b may generate video, audio or tactile output. The output unit 140b may include a display, a speaker and/or a haptic module. The sensing unit 140 may obtain at least one of internal information of the AI device 100, the surrounding environment information of the AI device 100 and user information using various sensors. The sensing unit 140 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The input unit 140a may acquire various types of data from the outside of the AI device 100. For example, the input unit 140a may acquire learning data for model learning, input data, to which the learning model will be applied, etc. The input unit 140a may include a camera, a microphone and/or a user input unit. The output unit 140b may generate video, audio or tactile output. The output unit 140b may include a display, a speaker and/or a haptic module. The sensing unit 140 may obtain at least one of internal information of the AI device 100, the surrounding environment information of the AI device 100 and user information using various sensors. The sensing unit 140 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

In summary, an embodiment may be implemented via a scheduling device and/or terminal.

For example, a device may be a BS, a network node, a transmitting terminal, a receiving terminal, a wireless device, a wireless communication device, a vehicle, a vehicle with autonomous driving capabilities, an unmanned aerial vehicle (UAV), an artificial intelligence (AI) module, a robot, an augmented reality (AR) device, a virtual reality (VR) device, or any other device.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi mode-multi band (MM-MB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

The wireless communication technology in which various embodiments are implemented may include LTE, NR, and 6G, as well as narrowband Internet of things (NB-IoT) for low power communication. For example, the NB-IoT technology may be an example of low power wide area network (LPWAN) technology and implemented as the standards of LTE category (CAT) NB1 and/or LTE Cat NB2. However, these specific appellations should not be construed as limiting NB-IoT. Additionally or alternatively, the wireless communication technology implemented in a wireless device according to various embodiments may enable communication based on LTE-M. For example, LTE-M may be an example of the LPWAN technology, called various names such as enhanced machine type communication (eMTC). For example, the LTE-M technology may be implemented as, but not limited to, at least one of 1) LTE CAT 0, 2) LTE Cat M1, 3) LTE Cat M2, 4) LTE non-bandwidth limited (non-BL), 5) LTE-MTC, 6) LTE machine type communication, and/or 7) LTE M. Additionally or alternatively, the wireless communication technology implemented in a wireless device according to various embodiments may include, but not limited to, at least one of ZigBee, Bluetooth, or LPWAN in consideration of low power communication. For example, ZigBee may create personal area networks (PANs) related to small/low-power digital communication in conformance to various standards such as IEEE 802.15.4, and may be referred to as various names.

Various embodiments of the disclosure may be implemented by various means. For example, various embodiments of the disclosure may be implemented in hardware, firmware, software, or a combination thereof.

In a hardware configuration, the methods according to exemplary embodiments of the disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the various embodiments of the disclosure may be implemented in the form of a module, a procedure, a function, etc. performing the above-described functions or operations. A software code may be stored in the memory and executed by the processor. The memory is located at the interior or exterior of the processor and may transmit and receive data to and from the processor via various known means.

Those skilled in the art will appreciate that the various embodiments of the disclosure may be carried out in other specific ways than those set forth herein without departing from the spirit and essential characteristics of the various embodiments of the disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the disclosure or included as a new claim by a subsequent amendment after the application is filed.

### INDUSTRIAL APPLICABILITY

The various embodiments of disclosure are applicable to various wireless access systems. Examples of the various wireless access systems include a 3GPP system or a 3GPP2 system. Besides these wireless access systems, the various embodiments of the disclosure are applicable to all technical fields in which the wireless access systems find their applications. Moreover, the proposed methods are also applicable to an mmWave communication system using an ultra-high frequency band.

1. A method performed by a user equipment (UE) in a wireless communication system, the method comprising:
receiving first configuration information related to a channel state information reference signal (CSI-RS), wherein the first configuration information includes at least one of information related to one or more CSI-RS resources for the CSI-RS or information related to a CSI-RS resource set including the one or more CSI-RS resources;
receiving second configuration information related to orbital angular momentum (OAM), wherein the second configuration information includes at least one of information related to one or more OAM resources or information related to an OAM resource set including the OAM resources; and
performing an operation related to OAM-based communication based on the second configuration information,
wherein the one or more OAM resources are for measuring an OAM state.

2. The method of claim 1, wherein at least one of the OAM resource set including the one or more CSI-RS resources, the one or more OAM resources, and one or more synchronization signal/physical broadcast channel (SS/PBCH) block resources or the CSI-RS resource set including the one or more CSI-RS resources and the one or more OAM resources is satisfied.

3. The method of claim 1, wherein based on the OAM resource set being periodically allocated, a periodicity of the periodically allocated OAM resource set is equal to a periodicity of the CSI-RS identified based on the first configuration information, or is identified based on the second configuration information, and
wherein an offset of the periodically allocated OAM resource set is equal to an offset of the CSI-RS identified based on the first configuration information, or is identified based on the second configuration information.

4. The method of claim 1, comprising receiving downlink control information (DCI) including information indicating whether to activate an OAM state measurement,
wherein based on the information indicating activation of the OAM state measurement, the OAM state is measured based on the one or more OAM resources, and
wherein based on the information indicating deactivation for the OAM state measurement, the one or more OAM resources are used as one or more CSI-RS resources different from the one or more CSI-RS resources.

5. The method of claim 1, further comprising transmitting information related to CSI in response to the first configuration information,
wherein the information related to the CSI includes information related to a CSI-RS resource indicator (CRI), and
wherein at least one of the one or more OAM resources or the OAM resource set is received based on a beam corresponding to the CRI or a beam having a quasi co-location (QCL) relationship with the beam corresponding to the CRI.

6. The method of claim 1, wherein performing the operation related to OAM-based communication includes transmitting information related to the OAM state.

7. The method of claim 1, comprising transmitting UE capability information about whether the UE supports the OAM,
wherein based on the UE capability information corresponding to the UE supporting the OAM, the second configuration information is received, and the operation related to OAM-based communication is performed.

8. A user equipment (UE) operating in a wireless communication system, comprising:
a transceiver; and
at least one processor coupled to the transceiver,
wherein the at least one processor is configured to:
receive first configuration information related to a channel state information reference signal (CSI-RS), wherein the first configuration information includes at least one of information related to one or more CSI-RS resources for the CSI-RS or information related to a CSI-RS resource set including the one or more CSI-RS resources;
receive second configuration information related to orbital angular momentum (OAM), wherein the second configuration information includes at least one of information related to one or more OAM resources or information related to an OAM resource set including the OAM resources; and
perform an operation related to OAM-based communication based on the second configuration information, and
wherein the one or more OAM resources are for measuring an OAM state.

9. The UE of claim 8, wherein at least one of the OAM resource set including the one or more CSI-RS resources, the one or more OAM resources, and one or more synchronization signal/physical broadcast channel (SS/PBCH) block resources or the CSI-RS resource set including the one or more CSI-RS resources and the one or more OAM resources is satisfied.

10. The UE of claim 8, wherein based on the OAM resource set being periodically allocated, a periodicity of the periodically allocated OAM resource set is equal to a periodicity of the CSI-RS identified based on the first configuration information, or is identified based on the second configuration information, and
wherein an offset of the periodically allocated OAM resource set is equal to an offset of the CSI-RS identified based on the first configuration information, or is identified based on the second configuration information.

11. The UE of claim 8, wherein the at least one processor is configured to communicate with at least one of a mobile terminal, a network, or an autonomous driving vehicle other than a vehicle including the UE.

12. A method performed by a base station (BS) in a wireless communication system, the method comprising:
transmitting first configuration information related to a channel state information reference signal (CSI-RS), wherein the first configuration information includes at least one of information related to one or more CSI-RS resources for the CSI-RS or information related to a CSI-RS resource set including the one or more CSI-RS resources;
transmitting second configuration information related to orbital angular momentum (OAM), wherein the second configuration information includes at least one of information related to one or more OAM resources or information related to an OAM resource set including the OAM resources; and
performing an operation related to OAM-based communication based on the second configuration information,
wherein the one or more OAM resources are for measuring an OAM state.

13.-15. (canceled)
